(19) United States
(12) Patent Application Publication
(10) Pub. No.: US 2005/0125477 A1
(43) Pub. Date: Jun. 9, 2005

(54) High-precision matrix-vector multiplication on a charge-mode array with embedded dynamic memory and stochastic method thereof

(76) Inventors: Roman A. Genov, Toronto (CA); Gert Cauwenberghs, Baltimore, MD (US)

Correspondence Address: Roman Genov, 30 Helena Ave., Toronto, ON, M6G 2H2, CA

(21) Appl. No.: 10/726,753

(22) Filed: Dec. 4, 2003

(51) Int. Cl. G06F 7/52

(52) U.S. Cl. 708/607

(57) ABSTRACT

Analog computational arrays for matrix-vector multiplication offer very large integration density and throughput as, for instance, needed for real-time signal processing in video. Despite the success of adaptive algorithms and architectures in reducing the effect of analog component mismatch and noise on system performance, the precision and repeatability of analog VLSI computation under process and environmental variations is inadequate for some applications. Digital implementation offers absolute precision limited only by wordlength, but at the cost of significantly larger silicon area and power dissipation compared with dedicated, fine-grain parallel analog implementation. The present invention comprises a hybrid analog and digital technology for fast and accurate computing of a product of a long vector (thousands of dimensions) with a large matrix (thousands of rows and columns). At the core of the externally digital architecture is a high-density, low-power analog array performing binary-binary partial matrix-vector multiplication. Digital multiplication of variable resolution is obtained with bit-serial inputs and bit-parallel storage of matrix elements, by combining quantized outputs from one or more rows of cells over time. Full digital resolution is maintained even with low-resolution analog-to-digital conversion, owing to random statistics in the analog summation of binary products. A random modulation scheme produces near-Bernoulli statistics even for highly correlated inputs. The approach has been validated by electronic prototypes achieving computational efficiency (number of computations per unit time using unit power) and integration density (number of computations per unit time on a unit chip area) each a factor of 100 to 10,000 higher than that of existing signal processors making the invention highly suitable for inexpensive micropower implementations of high-data-rate real-time signal processors.

### RELATED APPLICATIONS

The present patent application claims the benefit of the priority from U.S. provisional application 60/430,605 filed on Dec. 3, 2002.

### FIELD OF THE INVENTION

The invention is directed toward fast and accurate multiplication of long vectors with large matrices using analog and digital integrated circuits. This applies to efficient computing of discrete linear transforms, as well as to other signal processing applications.

### BACKGROUND OF THE INVENTION

The computational core of a vast number of signal processing and pattern recognition algorithms is that of matrix-vector multiplication (MVM):

$${Y}_{m} = {\sum }_{n = 0}^{N - 1} {W}_{mn} {X}_{n} \qquad ( Eq . 1 )$$

with N-dimensional input vector X, M-dimensional output vector Y, and N×M matrix elements Wₘₙ. In engineering, MVM can generally represent any discrete linear transformation, such as a filter in signal processing, or a recall in neural networks. Fast and accurate matrix-vector multiplication of large matrices presents a significant technical challenge.

Conventional general-purpose processors and digital signal processors (DSP) lack parallelism needed for efficient real-time implementation of MVM in high dimensions. Multiprocessors and networked parallel computers in principle are capable of high throughput, but are costly, and impractical for low-cost embedded real-time applications. Dedicated parallel VLSI architectures have been developed to speed up MVM computation. The problem with most parallel systems is that they require centralized memory resources i.e., memory shared on a bus, thereby limiting the available throughput. A fine-grain, fully-parallel architecture, that integrates memory and processing elements, yields high computational throughput and high density of integration [J. C. Gealow and C. G. Sodini, “A Pixel-Parallel Image Processor Using Logic Pitch-Matched to Dynamic Memory,” IEEE J. Solid-State Circuits, vol. 34, pp 831-839, 1999]. The ideal scenario (in the case of matrix-vector multiplication) is where each processor performs one multiply and locally stores one coefficient. The advantage of this is a throughput that scales linearly with the dimensions of the implemented array. The recurring problem with digital implementation is the latency in accumulating the result over a large number of cells. Also, the extensive silicon area and power dissipation of a digital multiply-and-accumulate implementation make this approach prohibitive for very large (1,000-10,000) matrix dimensions.

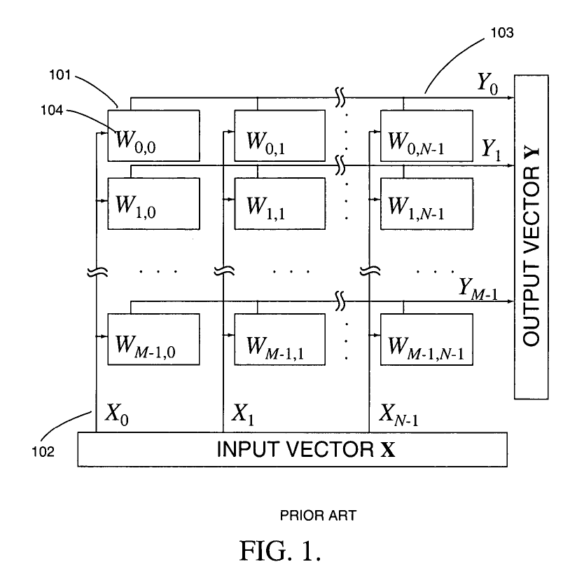

Analog VLSI provides a natural medium to implement fully parallel computational arrays with high integration density and energy efficiency [A. Kramer, “Array-based analog computation,” IEEE Micro, vol. 16 (5), pp. 40-49, 1996]. By summing charge or current on a single wire across cells in the array, low latency is intrinsic. Analog multiply-and-accumulate circuits are so small that one can be provided for each matrix element, making it feasible to implement massively parallel implementations with large matrix dimensions. Fully parallel implementation of (Eq. 1) requires an M×N array of cells, illustrated in FIG. 1. Each cell (m, n) (101) computes the product of input component Xₙ (102) and matrix element Wₘₙ (104), and dumps the resulting current or charge on a horizontal output summing line (103). The device storing Wₘₙ is usually incorporated into the computational cell to avoid performance limitations due to low external memory access bandwidth. Various physical representations of inputs and matrix elements have been explored, using charge-mode (U.S. Pat. No. 5,089,983 to Chiang; U.S. Pat. No. 5,258,934 to Agranat et al.; U.S. Pat. No. 5,680,515 to Barhen at al.) transconductance-mode [F. Kub, K. Moon, I. Mack, F. Long, “Programmable analog vector-matrix multipliers,” IEEE Journal of Solid-State Circuits, vol. 25 (1), pp. 207-214, 1990], [G. Cauwenberghs, C. F. Neugebauer and A. Yariv, “Analysis and Verification of an Analog VLSI Incremental Outer-Product Learning System,” IEEE Trans. Neural Networks, vol. 3 (3), pp. 488-497, May 1992.], or current-mode [A. G. Andreou, K. A. Boahen, P. O. Pouliquen, A. Pavasovic, R. E. Jenkins, and K. Strohbehn, “Current-Mode Subthreshold MOS Circuits for Analog VLSI Neural Systems,” IEEE Transactions on Neural Networks, vol. 2 (2), pp 205-213, 1991] multiply-and-accumulate circuits.

A hybrid analog-digital technology for fast and accurate charge-based matrix-vector multiplication (MVM) was invented by Barhen et al. in U.S. Pat. No. 5,680,515. The approach combines the computational efficiency of analog array processing with the precision of digital processing and the convenience of a programmable and reconfigurable digital interface. The digital representation is embedded in the analog array architecture, with inputs presented in bit-serial fashion, and matrix elements stored locally in bit-parallel form:

$$\begin{matrix}{W}_{mn} = {\sum }_{i = 0}^{I - 1} {2}^{- i - 1} {w}_{mn}^{( i )} & ( Eq . 2 ) \\ {X}_{n} = {\sum }_{j = 0}^{J - 1} {2}^{- j - 1} {x}_{n}^{( j )} & ( Eq . 3 )\end{matrix}$$

decomposing (Eq. 1) into:

$${Y}_{m} = {\sum }_{n = 0}^{N - 1} {W}_{mn} {X}_{n} = {\sum }_{i = 0}^{I - 1} {\sum }_{j = 0}^{J - 1} {2}^{- i - j - 2} {Y}_{m}^{( i , j )} \qquad ( Eq . 4 )$$

with binary-binary MVM partials:

$${Y}_{m}^{( i , j )} = {\sum }_{n = 0}^{N - 1} {w}_{mn}^{( i )} {x}_{n}^{( j )} . \qquad ( Eq . 5 )$$

The key is to compute and accumulate the binary-binary partial products (Eq. 5) using an analog MVM array, quantize them, and to combine the quantized results

$${Q}_{m}^{( i , j )} \approx {\sum }_{n = 0}^{N - 1} {w}_{mn}^{( i )} {x}_{n}^{( j )} . \qquad ( Eq . 6 )$$

according to (Eq. 4), now in the digital domain

$${Y}_{m} \approx {Q}_{m} = {\sum }_{i = 0}^{I - 1} {\sum }_{j = 0}^{J - 1} {2}^{- i - j - 2} {Q}_{m}^{( i , j )} \qquad ( Eq . 7 )$$

Digital-to-analog conversion at the input interface is inherent in the bit-serial implementation, and row-parallel analog-to-digital converters (ADCs) are used at the output interface to quantize Yₘ^{(i,j)}.

The bit-serial format of the inputs (Eq. 3) was first proposed by Agranat et al. in U.S. Pat. No. 5,258,934, with binary-analog partial products using analog matrix elements for higher density of integration. The use of binary encoded matrix elements (Eq. 2) relaxes precision requirements and simplifies storage as was described by Barhen et al. in U.S. Pat. No. 5,680,515. A number of signal processing applications mapped onto such an architecture was given by Fijany et al. in U.S. Pat. No. 5,508,538 and Neugebauer in U.S. Pat. No. 5,739,803. A charge injection device (CID) can be used as a unit computation cell in such an architecture as in U.S. Pat. No. 4,032,903 to Weimer, and U.S. Pat. No. 5,258,934 at Agranat et al.

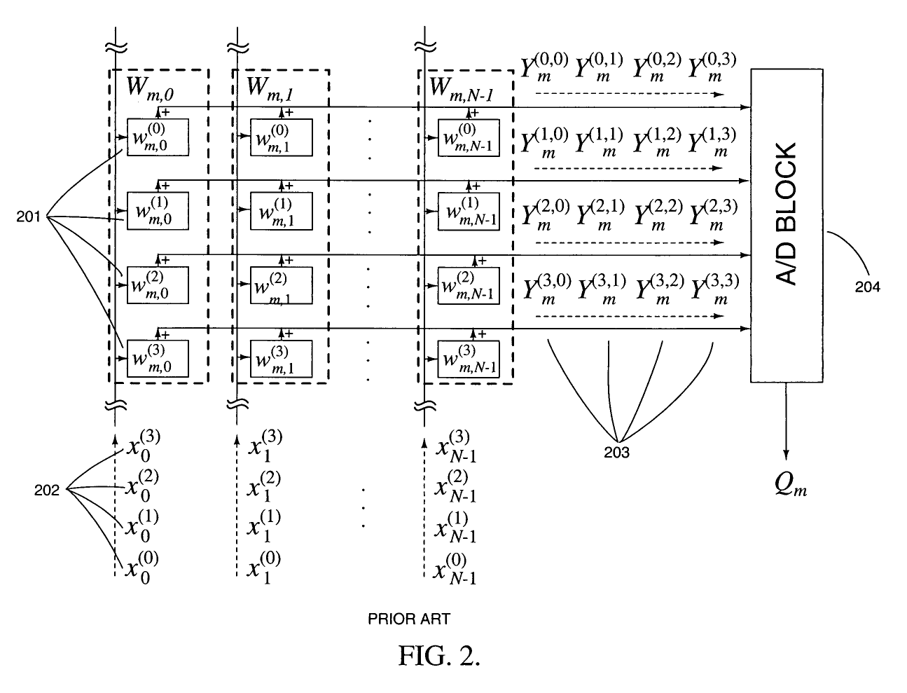

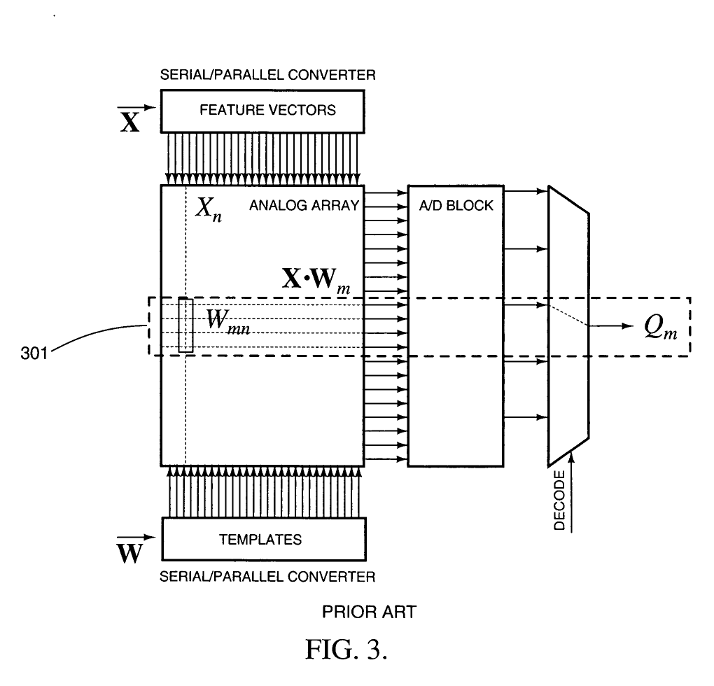

To conveniently implement the partial products (Eq. 5), the binary encoded matrix elements wₘₙ⁽ⁱ⁾ (201) are stored in bit-parallel form, and the binary encoded inputs xₙ^{(j)} (202) are presented in bit-serial fashion as shown in FIG. 2. The figure presents the block diagram of one row in the matrix with binary encoded elements wₘₙ⁽ⁱ⁾, for a single m and with I=4 bits, and the data flow of bit-serial inputs xₙ^{(j)} and corresponding partial outputs Yₘ^{(i,j)}, with J=4 bits. Analog partial products (203) (Eq. 5) are quantized and combined together in the analog-to-digital conversion block (204) to produce the output Qₘ (Eq. 7). FIG. 2 depicts a detailed block diagram of one slice (301) of the top level architecture based on U.S. Pat. No. 5,680,515 to Barhen et al. outlined with a dashed line in FIG. 3.

Despite the success of adaptive algorithms and architectures in reducing the effect of analog component mismatch and noise on system performance, the precision and repeatability of analog VLSI computation under process and environmental variations is inadequate for many applications. A need still exists therefore for fast and high-precision matrix-vector multipliers for very large matrices.

### SUMMARY OF THE INVENTION

It is one objective of the present invention to offer a charge-based apparatus to efficiently multiply large vectors and matrices in parallel, with integrated and dynamically refreshed storage of the matrix elements. The present invention is embodied in a massively-parallel internally analog, externally digital electronic apparatus for dedicated array processing that outperforms purely digital approaches with a factor 100-10,000 in throughput, density and energy efficiency. A three-transistor unit cell combines a single-bit dynamic random-access memory (DRAM) and a charge injection device (CID) binary multiplier and analog accumulator. High cell density and computation accuracy is achieved by decoupling the switch and input transistors. Digital multiplication of variable resolution is obtained with bit-serial inputs and bit-parallel storage of matrix elements, by combining quantized outputs from multiple rows of cells over time. Use of dynamic memory eliminates the need for external storage of matrix coefficients and their reloading.

It is another objective of the present invention to offer a method to improve resolution of charge-based and other large-scale matrix-vector multipliers through stochastic encoding of vector inputs. The present invention is also embodied in a stochastic scheme exploiting Bernoulli random statistics of binary vectors to enhance digital resolution of matrix-vector computation. Largest gains in system precision are obtained for high input dimensions. The framework allows to operate at full digital resolution with relatively imprecise analog hardware, and with minimal cost in implementation complexity to randomize the input data.

### DESCRIPTION OF DRAWINGS

1 General architecture for fully parallel matrix-vector multiplication

2 Block diagram of one row in the matrix with binary encoded elements and data flow of bit-serial inputs

3 Top level architecture of a matrix-vector multiplying processor

4 Circuit diagram of CID computational cell with integrated DRAM storage (top) and charge transfer diagram for active write and compute operations (bottom)

5 Two charge-mode AND cells configured as an exclusive-OR (XOR) multiply-and-accumulate gate

6 Two charge-mode AND cells with inputs time-multiplexed on the same node, configured as an exclusive-OR (XOR) multiply-and-accumulate gate

7 A single row of the analog array in the stochastic architecture with Bernoulli modulated signed binary inputs and fixed signed weights

8 Output of a single row of the analog array, Yₘ^{(i,j)} (bottom), and its probability distribution (top) in the stochastic architecture with Bernoulli encoded inputs

9 Input modulation and output reconstruction scheme in the stochastic MVM architecture

### DETAILED DESCRIPTION

The present invention enhances precision and density of the integrated matrix-vector multiplication architectures by using a more accurate and simpler CID/DRAM computational cell, and a stochastic input modulation scheme that exploits Bernoulli random statistics of binary vectors.

### CID/DRAM Cell

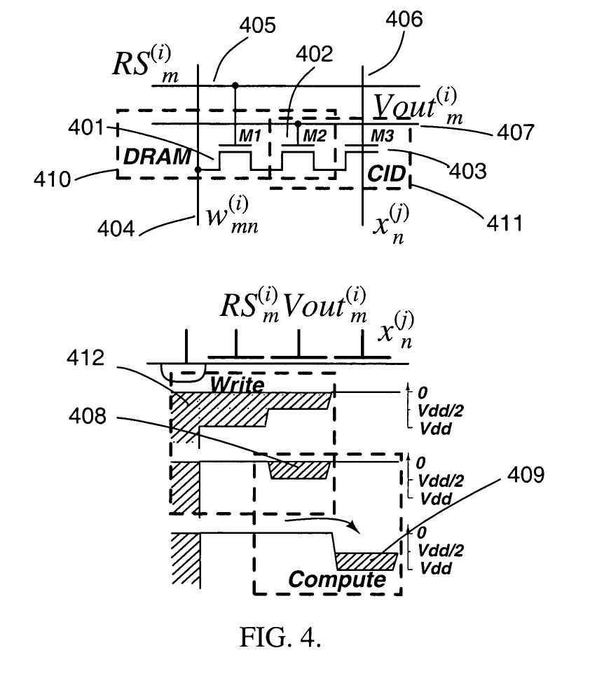

The circuit diagram and operation of the unit cell in the analog array are given in FIG. 4. It combines a CID computational element (411) with a DRAM storage element (410). The cell stores one bit of a matrix element wₘₙ⁽ⁱ⁾, performs a one-quadrant binary-binary multiplication of wₘₙ⁽ⁱ⁾ and xₙ^{(j)} in (Eq. 5), and accumulates the result across cells with common m and i indices. An array of cells thus performs (unsigned) binary multiplication (Eq. 5) of matrix wₘₙ⁽ⁱ⁾ and vector xₙ^{(j)} yielding Yₘ^{(i,j)}, for values of i in parallel across the array, and values of j in sequence over time.

The cell contains three MOS transistors connected in series as depicted in FIG. 4. Transistors M1 (401) and M2 (402) comprise a dynamic random-access memory (DRAM) cell, with switch M1 controlled by Row Select signal RSₘ⁽ⁱ⁾ on line (405). When activated, the binary quantity wₘₙ⁽ⁱ⁾ is written in the form of charge (either ΔQ or 0) stored under the gate of M2. Transistors M2 (402) and M3 (403) in turn comprise a charge injection device (CID), which by virtue of charge conservation moves electric charge between two potential wells in a non-destructive manner.

The bottom diagram in FIG. 4 depicts the charge transfer timing diagram for write and compute operations. The cell operates in two phases: Write/Refresh and Compute. When a matrix element value is being stored, xₙ^{(j)} is held at 0V and Vout at a voltage Vdd/2. To perform a write operation, either an amount of electric charge is stored under the gate of M2, if wₘₙ⁽ⁱ⁾ is low, or charge is removed, if wₘₙ⁽ⁱ⁾ is high. The charge (408) left under the gate of M2 can only be redistributed between the two CID transistors, M2 and M3. An active charge transfer (409) from M2 to M3 can only occur if there is non-zero charge (412) stored, and if the potential on the gate of M3 rises above that of M2 as illustrated in the bottom of FIG. 4. This condition implies a logical AND, i.e., unsigned binary multiplication, of wₘₙ⁽ⁱ⁾ on line (404) and xₙ^{(j)} on line (406). The multiply-and-accumulate operation is then completed by capacitively sensing the amount of charge transferred off the electrode of M2, the output summing node (407). To this end, the voltage on the output line, left floating after being pre-charged to Vdd/2, is observed. When the charge transfer is active, the cell contributes a change in voltage ΔVₒᵤₜ=ΔQ/C_{M2} where C_{M2} is the total capacitance on the output line across cells. The total response is thus proportional to the number of actively transferring cells. After deactivating the input xₙ^{(j)}, the transferred charge returns to the storage node M2. The CID computation is non-destructive and intrinsically reversible [C. Neugebauer and A. Yariv, “A Parallel Analog CCD/CMOS Neural Network IC,” Proc. IEEE Int. Joint Conference on Neural Networks (IJCNN'91), Seattle, Wash., vol. 1, pp 447-451, 1991], and DRAM refresh is only required to counteract junction and subthreshold leakage.

In one possible embodiment of the present invention, the gate of M2 is the output node and the gate of M3 is the input node. This configuration allows for simplified peripheral array circuitry as the potential on the bit-line wₘₙ⁽ⁱ⁾ is a truly digital signal driven to either 0 or Vdd. The signal-to-noise ratio of the cell presented in this invention is superior due to the fact that the potential well corresponding to M3 is twice deeper than that of M2.

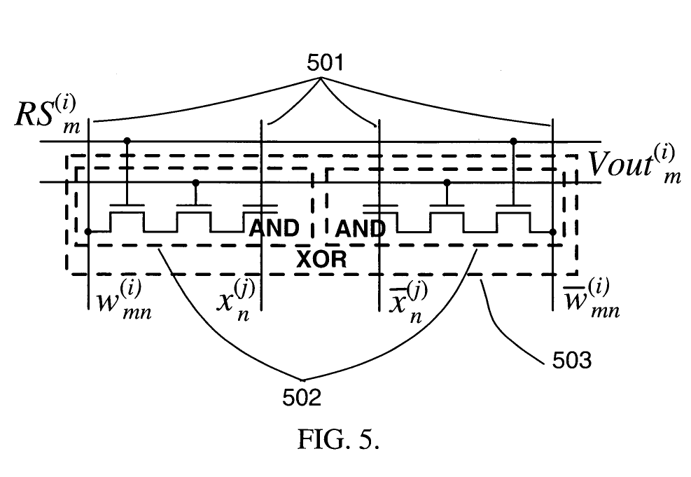

In another possible embodiment of the present invention, to improve linearity and to reduce sensitivity to clock feedthrough, differential encoding of input and stored bits in the CID/DRAM architecture using twice the number of columns (501) and unit cells (502) is implemented as shown in FIG. 5. This amounts to exclusive-OR (503) (XOR), rather than AND, multiplication on the analog array, using signed, rather than unsigned, binary values for inputs and weights, xₙ^{(j)}=±1 and wₘₙ⁽ⁱ⁾=±1.

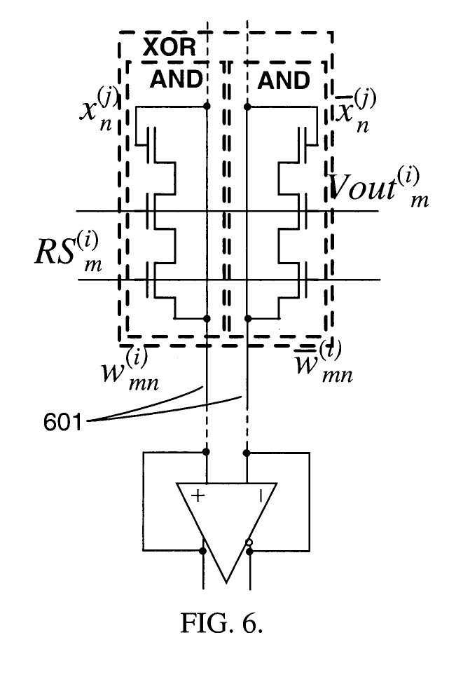

In another possible embodiment of the present invention, a more compact implementation for signed multiply-and-accumulate operation is possible using the CID/DRAM cell as the switch transistor M1 and input transistor M3 are decoupled by transistor M2 and can be multiplexed on the same wire. Both input and storage operations can be time-multiplexed on a single wire (601) as shown in FIG. 6. This makes the cell pitch in the array limited only by a single bit-line metal layer width allowing for a very dense array design.

### Resolution Enhancement Through Stochastic Encoding

Since the analog inner product (Eq. 5) is discrete, zero error can be achieved (as if computed digitally) by matching the quantization levels of the ADC with each of the N+1 discrete levels in the inner product. Perfect reconstruction of Yₘ^{(i,j)} from the quantized output, for an overall resolution of I+J+log₂(N+1) bits, assumes the combined effect of noise and nonlinearity in the analog array and the ADC is within one LSB (least significant bit). For large arrays, this places stringent requirements on analog computation precision and ADC resolution, L≧log₂(N+1).

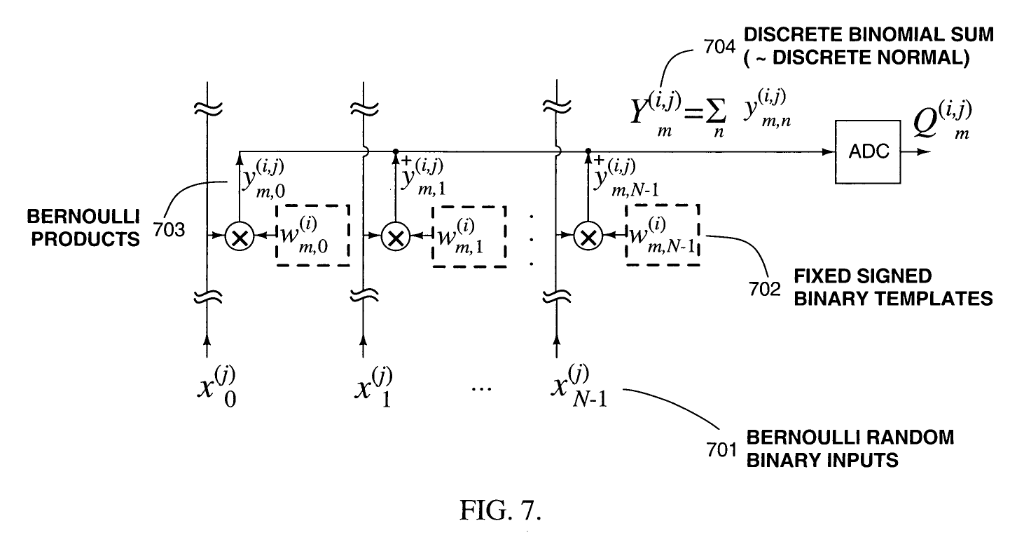

In what follows signed, rather than unsigned, binary values for inputs and weights, xₙ^{(j)}=±1 and wₘₙ⁽ⁱ⁾=±1 are assumed. This translates to exclusive-OR (XOR), rather than AND, multiplication on the analog array, an operation that can be easily accomplished with the CID/DRAM architecture by differentially coding input and stored bits using twice the number of columns and unit cells as shown in FIGS. 5 and 6. A single row of such a differential architecture is depicted in FIG. 7.

The implicit assumption is that all quantization levels are (equally) needed. Analysis of the statistics of the inner product reveals that this is poor use of available resources. The principle outlined below extends to any analog matrix-vector multiplier that assumes signed binary inputs and weights.

For input bits xₙ^{(j)} (701) that are Bernoulli (i.e., fair coin flips) distributed, and fixed signed binary coefficients wₘₙ⁽ⁱ⁾ (702), the (XOR) product terms wₘₙ⁽ⁱ⁾xₙ^{(j)} (703) in (Eq. 5) are Bernoulli distributed, regardless of wₘₙ⁽ⁱ⁾. Their sum Yₘ^{(i,j)} (704) thus follows a binomial distribution

$$Pr ( {Y}_{m}^{( i , j )} = 2 k - N ) = ( \begin{matrix}N \\ k\end{matrix} ) {{p}^{k} ( 1 - p )}^{N - k} \qquad ( Eq . 8 )$$

with p=0.5, k=0, . . . , N, which in the Central Limit N→∞ approaches a normal distribution with zero mean and variance N. In other words, for random inputs in high dimensions N the active range (or standard deviation) of the inner-product (704) (Eq. 5) is N^{1/2}, a factor N^{1/2} smaller than the full range N.

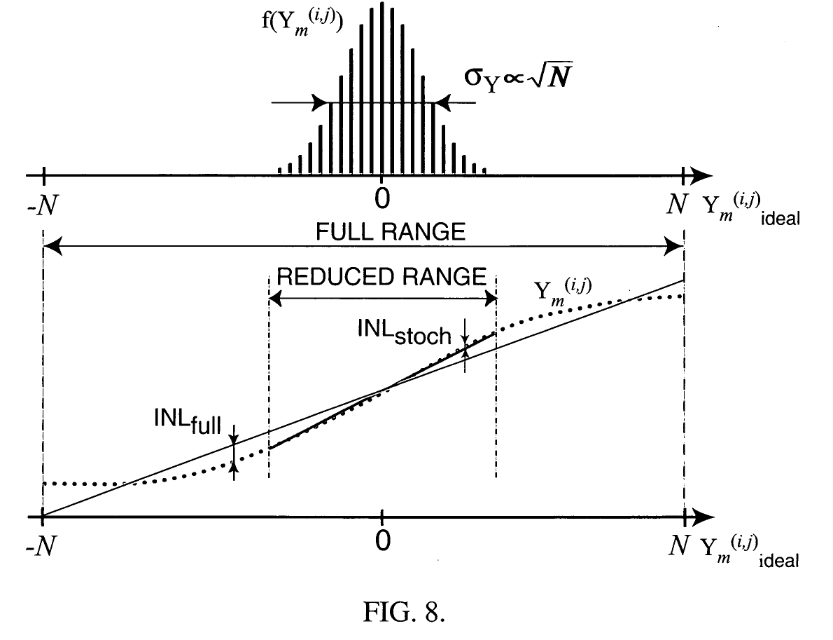

FIG. 8 illustrates the effect of Bernoulli distribution of the inputs on the statistics of an array row output. It depicts an illustration of the output of a single row of the analog array, Yₘ^{(i,j)}, and its probability density in the stochastic architecture with Bernoulli encoded inputs. On the top diagram of FIG. 8, Yₘ^{(i,j)} is a discrete random variable with probability density approaching normal distribution for large N. In Central limit the standard deviation is proportional to the square root of the full range, N^{1/2}. Reduction of the active range of the inner-product to N^{1/2} allows to relax the effective resolution of the ADC by a factor proportional to N^{1/2}, as the number of quantization levels is proportional to N^{1/2}, not N. This gain is especially beneficial for parallel (flash) quantizers in the architecture shown in FIG. 2, as their area requirements grow exponentially with the number of bits. On the bottom diagram of FIG. 8, Bernoulli modulation of inputs allows to significantly relax requirements on the linearity of the analog addition (Eq. 5) by making non-linearity outside the reduced active range irrelevant.

In principle, this allows to relax the effective resolution of the ADC. However, any reduction in conversion range will result in a small but non-zero probability of overflow. In practice, the risk of overflow can be reduced to negligible levels with a few additional bits in the ADC conversion range. An alternative strategy is to use a variable resolution ADC which expands the conversion range on rare occurrences of overflow (or, with stochastic input encoding, overflow detection could initiate a different random draw).

Although most randomly selected patterns do not correlate with any chosen template, patterns from the real world tend to correlate. The key is stochastic encoding of the inputs, as to randomize the bits presented to the analog array.

Randomizing an informative input while retaining the information is a futile goal, and the present invention comprises a solution that approaches the ideal performance within observable bounds, and with reasonable cost in implementation. Given that “ideal” randomized inputs relax the ADC resolution by log₂N/2 bits, they necessarily reduce the wordlength of the output by the same. To account for the lost bits in the range of the output, one could increase the range of the “ideal” randomized input by the same number of bits.

One possible stochastic encoding scheme that restores the range is to modulate the input with a random number. For each I-bit input component Xₙ, pick a random integer Uₙ in the range±(R−1), and subtract it to produce a modulated input \tilde{X}ₙ=Xₙ−Uₙ with log₂R additional bits. As one possible embodiment of the invention, one could choose R to be N^{1/2} leading to log₂N/2 additional bits in the input encoding.

It can be shown that for worst-case deterministic inputs Xₙ the mean of the inner product for \tilde{X}ₙ is off at most by ±N^{1/2} from the origin.

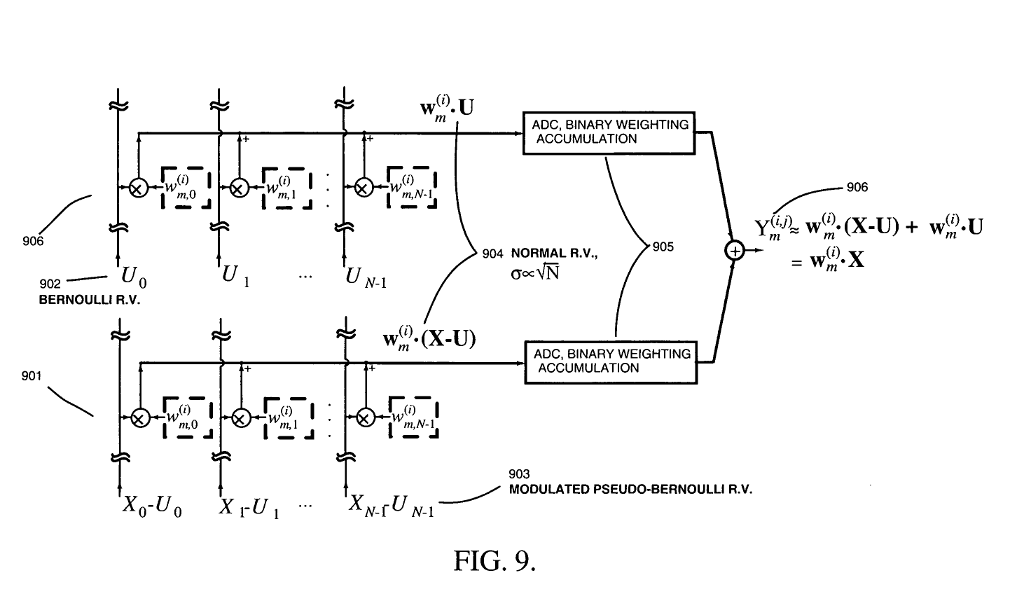

Note that Uₙ is uniformly distributed across its range, and therefore its binary coefficients uₙ^{(j)} are Bernoulli random variables. FIG. 9 illustrates this encoding method for particular i and j. Two rows (901) of the array are shown. Truly Bernoulli inputs uₙ^{(j)} (902) are fed into one row. The inputs of the other row are stochastically modulated binary coefficients of the informative input \tilde{x}ₙ−xₙ−uₙ (903). Inner-products (904) of approximately normal distribution are computed on both rows. Their smaller active range allows to relax the requirements on the resolution of the quantizer (905) by a factor N^{1/2}. The desired inner-products for Xₙ (906) are retrieved by digitally adding the inner-products obtained for \tilde{X}ₙ and Uₙ. The random offset Uₙ can be chosen once, so its inner-product with the templates can be pre-computed upon initializing or programming the array (in other words, the computation performed by the top row in FIG. 9 takes place only once). The implementation cost is thus limited to component-wise subtraction of Xₙ and Uₙ, achieved using one full adder cell, one bit register, and ROM (read-only memory) storage of the uₙ⁽ⁱ⁾ bits for every column of the array.

1. An apparatus performing parallel binary-binary matrix-vector multiplication with embedded storage of the matrix; the apparatus comprising an array of charge-based cells receiving binary inputs, storing binary matrix elements and returning analog outputs; each cell comprising:
A first device storing charge representing one said binary matrix element, the stored charge coupling capacitively to an output line;
A second device coupled to said first device, where transfer of said charge between said first and second device in a computation cycle is controlled by an input line;
A third device coupled to said first device and to a data line, where write or refresh of said charge is activated onto said data line through a select line.

2. The apparatus recited in claim 1 wherein said first, second and third device in said charge-based cell comprise field effect transistors.

3. The apparatus recited in claim 1 further comprising circuits assisting in write and dynamic refresh of said charge in said charge-based cells.

4. The apparatus recited in claim 1 wherein said analog outputs are converted to digital outputs through quantization.

5. The apparatus recited in claim 1 performing digital-digital matrix-vector multiplication; the apparatus comprising said array of charge-based cells receiving bit-serial digital inputs over multiple computation cycles, storing bit-parallel matrix elements spanning multiple rows of said array, and returning analog or digital outputs combining analog or quantized outputs from said array over said computation cycles and said rows.

6. The apparatus recited in claim 1 performing parallel signed binary-binary matrix-vector multiplication with embedded storage of the matrix; the apparatus comprising an array of complementary cells receiving complementary signed binary inputs, storing complementary signed binary matrix elements and returning analog outputs; each complementary cell comprising two said charge-based cells; each charge-based cell receiving one polarity of said input and storing one polarity of said matrix element.

7. The apparatus recited in claim 6 wherein said analog outputs are converted to digital outputs through quantization.

8. The apparatus recited in claim 6 performing signed digital-digital matrix-vector multiplication; the apparatus comprising said array of complementary cells receiving complementary bit-serial digital inputs over multiple computation cycles, storing complementary bit-parallel matrix elements spanning multiple rows of said array, and returning analog or digital outputs combining analog or quantized outputs from said array over said computation cycles and said rows.

9. A method for large-scale high-resolution digital matrix-vector multiplication using a parallel signed binary-binary matrix-vector multiplier; said matrix-vector multiplier receiving signed binary inputs, storing signed binary matrix elements and returning analog outputs; the method comprising:
modulation of digital inputs to produce pseudo-random inputs;
signed bit-serial presentation of said pseudo-random inputs to said signed binary-binary matrix-vector multiplier;
quantization of corresponding analog outputs to produce partial digital outputs;
combination of said partial digital outputs to produce pseudo-random digital outputs;
demodulation of said pseudo-random digital outputs to undo the effect of said modulation of said digital inputs, producing desired digital outputs.

10. The method of claim 9 using a parallel signed digital-binary matrix-vector multiplier; said matrix-vector multiplier receiving signed binary inputs, storing digital matrix elements in signed bit-parallel form over multiple rows, and returning analog outputs; said combination of said partial digital outputs spanning said multiple rows.

11. The method of claim 10 wherein said digital inputs are modulated by digitally subtracting reference inputs drawn from a random distribution to produce said pseudo-random inputs, and wherein said pseudo-random digital outputs are demodulated by digitally adding the result of multiplying said digital matrix with said reference inputs to produce said desired digital outputs.

12. The method of claim 11 wherein said result of multiplying said digital matrix with said reference inputs is obtained from said digital-binary matrix multiplier.

13. The method of claim 11 wherein said reference inputs are fixed, and wherein said result of multiplying said digital matrix with said reference inputs is precomputed and stored.
